(19) United States
(12) Patent Application Publication
(10) Pub. No.: US 2024/0381466 A1
(43) Pub. Date: Nov. 14, 2024

(54) COMMUNICATION METHODS AND DEVICE TO SIGNAL ENHANCED MULTI-LINK OPERATING MODE

(71) Applicant: CANON KABUSHIKI KAISHA, Tokyo (JP)

(72) Inventors: Julien SEVIN, SAINT AUBIN DU CORMIER (FR); Mickael LORGEOUX, RENNES (FR)

(21) Appl. No.: 18/692,675

(22) PCT Filed: Sep. 14, 2022
(86) PCT No.: PCT/EP2022/075569

§ 371 Date: Mar. 15, 2024

(30) Foreign Application Priority Data
Sep. 15, 2021 (GB) 2113205.5

(51) Int. Cl. H04W 76/15

(52) U.S. Cl. CPC H04W 76/15

(57) ABSTRACT

In wireless networks implementing multilink transmissions, an AP MLD spontaneously sends an EML OM Notification frame defining a proposal or suggestion to activate or deactivate or modify an EML OM, optionally with a proposed set of EML Links. Taking advantage of this opportunity, the addressee non-AP MLD initiates an EML OM activation or deactivation as suggested. Upon receiving a request for EML OM activation or deactivation, the AP MLD may refuse the request and respond with another proposed set of links. The signalling in the requesting frames may be simplified by using a single one-bit field to implicitly activate or deactivate the single EML OM, either EMLSR or EMLMR mode, declared as supported during the association of the non-AP MLD.

### CROSS-REFERENCE TO RELATED APPLICATIONS

This application is a National Phase application of PCT Application No. PCT/EP2022/075569, filed on Sep. 14, 2022 and titled “COMMUNICATION METHODS AND DEVICE TO SIGNAL ENHANCED MULTI-LINK OPERATING MODE”, which claims the benefit under 35 U.S.C. § 119(a)-(d) of United Kingdom Patent Application No. 2113205.5, filed on Sep. 15, 2021 and entitled “COMMUNICATION METHODS AND DEVICE TO SIGNAL ENHANCED MULTI-LINK OPERATING MODE”. The above cited patent applications are incorporated herein by reference in their entireties.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between stations.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D1.1 version (July 2021, below “D1.1 standard”) introduces the Multi-Link (ML) Operation (MLO). MLO improves data throughput by allowing communications between stations over multiple concurrent and non-contiguous communication links.

MLO enables a non-AP (Access Point) MLD (ML Device) to register with an AP MLD, i.e. to discover, authenticate, associate and set up multiple links with the AP MLD. Each link enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP MLD can use 802.11 mechanisms to communicate with affiliated stations of another MLD over each of the multiple communication links that are set up.

With the introduction of MLO and of spatial multiplexing capabilities of the MLDs, new Operating Modes (OM), referred to as Enhanced Multi-Link Operating Mode (EML OM), have been introduced in the D1.1 standard, namely the EMLSR (Enhanced Multi-Link Single Radio) mode and the EMLMR (Enhanced Multi-Link Multi-Radio) mode.

In the EMLSR mode, a non-AP MLD is able to simultaneously listen to a set of enabled links (so-called EMLSR links) for receiving initial control frame (e.g. MU-RTS, BSRP) from the AP MLD and can perform data frames exchange with the AP MLD over only one link at a time, usually the link over which the initial control frame has been received.

In the EMLMR mode, a non-AP MLD is able to aggregate some physical resources of its multiple radios dedicated to multiple enabled links (so-called EMLMR links), in order to transmit or receive data up to a pre-defined number of supported Rx/Tx spatial streams. This predefined number is higher than the number of supported Rx/Tx spatial streams of each radio, hence providing throughput enhancement and latency reduction. As an example, a multi-radio (MR) non-AP MLD supporting the EMLMR mode on two links (with associated radios) communicates over the two links using the two radios when the EMLMR mode is deactivated, for example in a 2×2 MIMO antenna configuration. On the other hand, it communicates over one of the two links using one of its radios with the aggregated physical resources of the two radios (typically the antennas) when the EMLMR mode is activated, for example in a 4×4 MIMO antenna configuration. In the meantime, the other link (deprived of its physical antenna) cannot be used.

The non-AP MLDs declare their support of each of the EML Operating Modes (known as EML Capabilities) to the AP MLD during the association phase.

In operation mode, the activation (so-called “Initiation”) and the deactivation (so-called “Termination”) of an EML Operation Mode is initiated by the non-AP MLD which sends a specific EHT action frame referred to as “EML OM Notification”. The EML OM Notification frame includes one bit for each of the EMLSR mode and the EMLMR mode, in order to signal which mode is concerned by the activation or deactivation.

The current activation/deactivation scheme is not fully satisfactory.

For instance, the proposed signaling induces overhead and thus may be improved.

Also, the scheme is mainly driven by the non-AP MLD's own constraints, without considering the overall state of the network.

### SUMMARY OF INVENTION

It is a broad objective of the present invention to overcome some of the foregoing concerns.

In this context, embodiments of the invention provide a communication method in a wireless network, comprising at an access point, AP, multi-link device, MLD:
sending, to a non-AP MLD, a first Enhanced Multi-Link Operating Mode, EML OM, Notification frame defining a proposal from the AP MLD to activate or deactivate or modify an EML OM.

Correspondingly, a communication method in a wireless network, comprises at a non-access point, non-AP, multi-link device MLD:
receiving, from an AP MLD, a first Enhanced Multi-Link Operating Mode, EML OM, Notification frame defining a proposal from the AP MLD to activate or deactivate or modify an EML OM.

Such a proposal is thus submitted to an approval of the non-AP MLD which in turns can request the proposed activation/deactivation/modification in case of approval as described below.

Contrary to the conventional activation/deactivation scheme where the non-AP MLD initiates the exchange of Notification frames, the AP MLD may here spontaneously send the first EML OM Notification frame. “Spontaneous” means here at the AP MLD's own initiative, without any prompt from the non-AP MLD. For example, the sending of the proposal is not in response to a frame (e.g. an EML OM Notification frame) received from the non-AP MLD. Such spontaneous sending of the AP MLD means that the AP MLD takes the initiative to propose to activate, deactivate or modify an EML OM.

This approach makes it possible to take into account the AP MLD's overall view of the network in the process of deciding to activate or deactivate or even modify an EML OM.

Optional features of these embodiments of the invention are defined below with reference to a method, while they can be transposed into device features.

In some embodiments, the method at the AP MLD comprises in response to the sending, receiving, from the non-AP MLD, a requesting EML OM Notification frame requesting an activation or deactivation of the EML OM. This confirms the non-AP MLD conventionally driving the activation/deactivation scheme has taken into account the proposal from the AP MLD. Correspondingly, the method at the non-AP MLD comprises, in response to the received frame, sending, to the AP MLD, a requesting EML OM Notification frame requesting an activation or deactivation of the EML OM.

In yet other embodiments, the first EML OM Notification frame includes a field, e.g. an EML Link Bitmap field, signaling a proposed set of links for activating or modifying the EML OM between the two MLDs. Therefore, a set of EMLSR or EMLMR link candidates is proposed by the AP MLD to be used for the resulting EML OM (either activated or modified). Indeed, the requested MLD may desire to use specific EML links for the EML OM.

In some embodiments, the requesting EML OM Notification frame includes the same proposed set of links for the requested EML OM. This confirms the non-AP MLD initiates an activation or modification of the EML OM using the EMLSR or EMLMR links desired by the AP.

In variants, the requesting EML OM Notification frame includes a set of links different from the proposed set of links, for the requested EML OM. This lets open to the non-AP MLD the possibility to modify the proposed links into more efficient links from its own point of view.

In some embodiments, the EML OM Notification frames include an EML Mode subfield set to the same activation or deactivation value (e.g. 1 to activate the mode). This confirms the proposal from the AP MLD has been taken into account by the requesting non-AP MLD.

In some embodiments, the method further comprises exchanging, from the AP MLD to the non-AP MLD, an acknowledgment frame acknowledging the requesting EML OM Notification frame and triggering an actual activation or deactivation of the requested EML OM. The acknowledgment may be a mere MAC ack frame or another EML OM Notification frame or both.

In some embodiments, the first EML OM Notification frame proposes to modify a currently active EML OM, and the method at the AP MLD comprises in response to the sending of such frame, receiving, from the non-AP MLD, a first requesting EML OM Notification frame requesting a deactivation of the currently active EML OM and then a second requesting EML OM Notification frame requesting an activation of the same EML OM with a set of links different from links of the currently active EML OM. This illustrates a two-step procedure to modify a currently EML OM with a new set of links. Correspondingly, the method at the non-AP MLD comprises, in response to the received frame, sending, to the AP MLD, a first requesting EML OM Notification frame requesting a deactivation of the currently active EML OM and then a second requesting EML OM Notification frame requesting an activation of the same EML OM with a set of links different from links of the currently active EML OM.

In some embodiments, the set of links different from links of the currently active EML OM is a proposed set of links signaled in the first EML OM Notification frame. In other words, it is a set of links that is proposed by the AP MLD to modify the currently EML OM.

Some embodiments of the invention overcoming some of the above concerns provide a communication method in a wireless network, comprising at a requested multi-link device, MLD, e.g. an access point, AP, MLD:
responsive to receiving, from a requesting MLD, e.g. a non-AP MLD, a first requesting Enhanced Multi-Link Operating Mode, EML OM, Notification frame requesting an activation of an EML OM, sending, to the requesting MLD, a responding EML OM Notification frame signaling a proposed set of links for activating the EML OM.

Correspondingly, a communication method in a wireless network, comprises at a requesting multi-link device, MLD, e.g. a non-AP MLD:
sending, to a requested MLD, e.g. an AP MLD, a first requesting Enhanced Multi-Link Operating Mode, EML OM, Notification frame requesting an activation of an EML OM,
in response, receiving, from the requested MLD, a responding EML OM Notification frame signaling a proposed set of links for activating the EML OM.

This approach makes it possible to take into account other MLD's knowledge of the network state (through its proposal of links for the activation) in the management of the EML OM.

Optional features of these embodiments of the invention are defined below with reference to a method, while they can be transposed into device features.

In some embodiments, the method at the requested MLD further comprises subsequently receiving, from the requesting MLD, a second requesting EML OM Notification frame requesting the activation of the EML OM using the proposed set of links. This confirms the requesting MLD driving the activation/deactivation scheme has taken into account the proposal from the requested MLD. Correspondingly, at the requesting MLD, the method further comprises in response to receiving the responding EML OM Notification frame, sending, to the requested MLD, a second requesting EML OM Notification frame requesting the activation of the EML OM using the proposed set of links.

In some embodiments, the first requesting EML OM Notification frame includes a field, e.g. an EML Link Bitmap field, to signal links that is empty. Such signaling of an empty (bitmap) field may mean the requested MLD wishes to activate an EML operating mode but does not know which links to use. The present invention then advantageously allows the requested MLD to signal which links to be used.

In variants, the first requesting EML OM Notification frame signals a set of links different from the proposed set of links. This means the requested MLD takes advantage of the present invention to provide an alternative set of links compared to the one initially considered by the requesting MLD. This indeed contributes to use a link set more adapted to the requested MLD's knowledge of the network.

In some embodiments, the responding EML OM Notification frame includes an EML Mode subfield set to the same activation value (e.g. 1 to activate the mode) for the requested EML OM as the first requesting EML OM Notification frame. Hence, the pair {same activation value, new link bitmap} allows the requesting MLD to know another set of links has to be used for the activation.

In variants, the responding EML OM Notification frame includes an EML Mode subfield set to an opposite value (e.g. 0) to an activation value (e.g. 1 to activate the mode) of the same subfield in the first requesting EML OM Notification frame. Hence, the pair {opposite activation value, new link bitmap} warns the requesting MLD that either no EML Mode is activated or it is activated with the new (proposed) set of links.

In some embodiments, the requesting MLD is configured to start a local Transition Timeout timer upon receiving an acknowledgment to an emitted EML OM Notification frame requesting an activation or deactivation of an EML OM, at the expiry of which the requested activation or deactivation is actually executed, and the method further comprises, at the requesting MLD, not starting its local Transition Timeout timer upon receiving an acknowledgment to the first requesting EML OM Notification frame when the latter includes a field, e.g. an EML Link Bitmap field, to signal links that is empty. Similarly, the requested MLD is configured to start a local Transition Timeout timer upon sending an acknowledgment to a received EML OM Notification frame requesting an activation or deactivation of an EML OM, at the expiry of which the requested activation or deactivation is actually executed, and the method further comprises, at the requested MLD, not starting its local Transition Timeout timer upon sending an acknowledgment to the first requesting EML OM Notification frame when the latter includes a field to signal links that is empty. This avoids the MLDs to automatically activate the requested EML OM although no EML links have been defined.

Some embodiments of the invention overcoming some of the above concerns provide a communication method in a wireless network, comprising at a requested multi-link device, MLD, e.g. an access point, AP, MLD:
receiving, from a requesting MLD, a requesting Enhanced Multi-Link, EML, Operating Mode, OM, Notification frame requesting an activation or deactivation of an EML Single-Radio, EMLSR, OM or of an EML Multi-Radio, EMLMR, OM,
wherein the requesting EML OM Notification frame includes a single bitmap subfield that indicates either a set of links to be used in the EMLSR OM if the requesting EML OM Notification frame requests an activation of the EMLSR OM or a set of links to be used in the EMLMR OM if the requesting EML OM Notification frame requests an activation of the EMLMR OM.

Correspondingly, a communication method in a wireless network, comprises at a requesting multi-link device, MLD:
sending, to a requested MLD, a requesting Enhanced Multi-Link, EML, Operating Mode, OM, Notification frame requesting an activation or deactivation of an EML Single-Radio, EMLSR, OM or of an EML Multi-Radio, EMLMR, OM,
wherein the requesting EML OM Notification frame includes a single bitmap subfield that indicates either a set of links to be used in the EMLSR OM if the requesting EML OM Notification frame requests an activation of the EMLSR OM or a set of links to be used in the EMLMR OM if the requesting EML OM Notification frame requests an activation of the EMLMR OM.

The same subfield is therefore used to signal which EML links to be used whatever the EMLSR or EMLMR OM is activated. This simplifies the frame format while saving bits.

Optional features of these embodiments of the invention are defined below with reference to a method, while they can be transposed into device features.

In some embodiments, the requesting EML OM Notification frame is deprived of bitmap subfields indicating a set of links for an EML OM, if the requesting EML OM Notification frame requests a deactivation of both EMLSR OM and EMLMR OM.

In some embodiments, the requesting EML OM Notification frame includes an EMLSR Mode subfield to be set to 1 or 0 to respectively request an activation or deactivation of the EMLSR mode and an EMLMR Mode subfield to be set to 1 or 0 to respectively request an activation or deactivation of the EMLMR mode.

In embodiments, when the EMLSR Mode subfield is set to 1, the single bitmap subfield indicates a set of links to be used in the EMLSR OM, when the EMLMR Mode subfield is set to 1, the single bitmap subfield indicates a set of links to be used in the EMLMR OM, and when the EMLSR Mode subfield is set to 0 and the EMLMR Mode subfield is set to 0, the requesting EML OM Notification frame is deprived of bitmap subfields indicating a set of links for an EML OM.

Some embodiments of the invention overcoming some of the above concerns provide a communication method in a wireless network, comprising at a requested multi-link device, MLD, e.g. an access point, AP, MLD:
receiving, from a requesting MLD, e.g. a non-AP MLD, a capability declaration that the requesting MLD supports Enhanced Multi-Link, EML, operations,
subsequently receiving, from the requesting MLD, a requesting EML Operating Mode, OM, Notification frame requesting an activation or deactivation of an EML OM, and
in case a one-bit field of the requesting EML OM Notification frame is set to a first value, activating an EML Single-Radio, EMLSR, OM with the requesting MLD if the capability declares the non-AP MLD supports EMLSR operations or activating an EML Multi-Radio, EMLMR, OM with the requesting MLD if the capability declares the non-AP MLD supports EMLMR operations.

Correspondingly, a communication method in a wireless network, comprises at a requesting multi-link device, MLD, e.g. a non-AP MLD:
declaring, to a requested MLD, e.g. an AP MLD, a capability to support Enhanced Multi-Link, EML, operations,
sending, to the requested MLD, a requesting EML Operating Mode, OM, Notification frame requesting an activation or deactivation of an EML OM, and
in case a one-bit field of the requesting EML OM Notification frame is set to a first value, activating an EML Single-Radio, EMLSR, OM with the requested MLD if the capability declares the non-AP MLD supports EMLSR operations or activating an EML Multi-Radio, EMLMR, OM with the requested MLD if the capability declares the non-AP MLD supports EMLMR operations.

Thanks to the capability declaration for one or the other of EMLSR and EMLMR operation support, a single one-bit field may be enough to request an activation or deactivation of an EML OM, implicitly EMLSR or EMLMR mode given the declared capability. Such enhanced signaling saves overhead compared to the signaling defined in the D1.1 standard.

Optional features of these embodiments of the invention are defined below with reference to a method, while they can be transposed into device features.

In some embodiments, the method further comprises deactivating a current active EML OM when the one-bit field is set to a second value different from the first value.

In some embodiments, the capability declaration is conveyed in a field having a first subfield to declare support of EMLSR operations and a second subfield to declare support of EMLMR operations, one only of the two subfields being enabled. Hence, the two supports are exclusive one to the other.

In other embodiments, the requesting EML OM Notification frame includes a field, e.g. an EML Link Bitmap field, signaling a set of links for activating the EMLSR or EMLMR OM between the two MLDs. Therefore, a set of EMLSR or EMLMR link candidates is proposed by the requesting MLD.

Some embodiments of the invention overcoming some of the above concerns provide a communication method in a wireless network, comprising at a requested multi-link device, MLD, e.g. an access point, AP, MLD:
receiving, from a requesting MLD, e.g. a non-AP MLD, a first requesting Enhanced Multi-Link Operating Mode, EML OM, Notification frame requesting an activation of an EML OM, the first requesting EML OM Notification frame including a field, e.g. an EML Link Bitmap field, signaling a set of links to be used in the EML OM,
exchanging data with the requesting MLD using the activated EML OM, and
receiving, from the requesting MLD, a second requesting EML OM Notification frame requesting a deactivation of the activated EML OM, the second requesting EML OM Notification frame being deprived of a field, e.g. an EML Link Bitmap field, signaling a set of links.

Correspondingly, a communication method in a wireless network, comprises at a requesting multi-link device, MLD, e.g. a non-AP MLD:
sending, to a requested MLD, e.g. an AP MLD, a first requesting Enhanced Multi-Link Operating Mode, EML OM, Notification frame requesting an activation of an EML OM, the first requesting EML OM Notification frame including a field signaling a set of links to be used in the EML OM,
exchanging data with the requested MLD using the activated EML OM, and
sending, to the requested MLD, a second requesting EML OM Notification frame requesting a deactivation of the activated EML OM, the second requesting EML OM Notification frame being deprived of a field signaling a set of links.

This communication scheme provides asymmetry between the two requesting EML OM Notification frames because the second one for deactivation does not include a bitmap for EMLSR or EMLMR links, contrary to the first frame. This reduces overhead in the activation/deactivation scheme compared to technics involving a link bitmap in the Notification frames.

Some embodiments of the invention overcoming some of the above concerns provide a communication method in a wireless network, comprising at a requested multi-link device, MLD, e.g. an access point, AP, MLD:
responsive to receiving, from a requesting MLD, e.g. a non-AP MLD, a requesting Enhanced Multi-Link Operating Mode, EML OM, Notification frame requesting an activation or deactivation of an EML OM, sending, to the requesting MLD, a responding EML OM Notification frame refusing the activation or deactivation.

Correspondingly, a communication method in a wireless network, comprises at a requesting multi-link device, MLD, e.g. a non-AP MLD:
sending, to a requested MLD, e.g. an AP MLD, a requesting Enhanced Multi-Link Operating Mode, EML OM, Notification frame requesting an activation or deactivation of an EML OM,
in response, receiving, from the requested MLD, a responding EML OM Notification frame refusing the activation or deactivation.

This approach allows the activation/deactivation scheme to take into account the knowledge of the network by other MLDs than the requesting MLD soliciting the EML OM activation. Indeed, an MLD such as an AP of a BSS may have some information and some constraints that the requesting MLDs do not know, such as a quantity of data to be sent in downlink intended to non-AP MLD, current interferences in the BSS or NSTR constraints if the AP MLD is a soft-AP. Hence, the requested MLD can decide refusing a request to enter or leave an EML OM in order to keep efficiency of the network.

Optional features of these embodiments of the invention are defined below with reference to a method, while they can be transposed into device features.

In some embodiments, the requesting EML OM Notification frame includes an EML Mode subfield set to an activation or deactivation value (e.g. 1 to activate the mode) for the requested EML OM and the responding EML OM Notification frame includes an EML Mode subfield set to an opposite value (e.g. 0) for the requested EML OM. The EML OM Notification frames can thus keep the format defined in the D1.1 standard.

In other embodiments, the responding EML OM Notification frame is included in the same Physical Protocol Data Unit, PPDU, as an (MAC) acknowledgment to the requesting EML OM Notification frame. The requesting MLD thus has knowledge of the refusal before starting its Transition Timeout timer (upon receiving the acknowledgment), at the expiry of which the requested EML OM is activated or deactivated.

In some embodiments, the requesting MLD is configured to start a local Transition Timeout timer upon receiving an acknowledgment to an emitted EML OM Notification frame requesting an activation or deactivation of an EML OM, at the expiry of which the requested activation or deactivation is actually executed, and the method further comprises, at the requesting MLD, not starting its local Transition Timeout timer upon receiving an acknowledgment to the requesting EML OM Notification frame that is included in the same Physical Protocol Data Unit, PPDU, as the responding EML OM Notification frame refusing the activation or deactivation. Similarly, the requested MLD is configured to start a local Transition Timeout timer upon sending an acknowledgment to a received EML OM Notification frame requesting an activation or deactivation of an EML OM, at the expiry of which the requested activation or deactivation is actually executed, and the method further comprises, at the requested MLD, not starting its local Transition Timeout timer upon sending an acknowledgment to the requesting EML OM Notification frame that is included in the same Physical Protocol Data Unit, PPDU, as the responding EML OM Notification frame refusing the activation or deactivation. This avoids the MLDs to automatically activate the requested EML OM although a refusal thereof is pending.

In yet other embodiments, the responding EML OM Notification frame includes a field, e.g. an EML Link Bitmap field, signaling a proposed set of links for activating the EML OM between the two MLDs. Therefore, a set of EMLSR or EMLMR link candidates is proposed by the requested MLD refusing for instance a requested EML OM activation. This particularly applies when refusing a request to activation an EML OM due to inappropriate EML links. Indeed, the requested MLD may desire to use specific EML links should an EML OM mode be activated.

According to specific embodiments, the proposed set of links is different from a first set of links signaled in the requesting EML OM Notification. This allows the requested MLD to refuse the activation of the EML OM due to the links signaled by the requesting MLD in its request, while proposing new links for the activation.

In that case, the method may further comprise, exchanging, from the requesting MLD to the requested MLD, a subsequent EML OM Notification frame requesting an activation of an EML OM with the proposed set of links. In that case, the proposed links have been taken into account by the requesting MLD to initiate the EML OM.

Correlatively, the invention also provides a wireless communication device comprising at least one microprocessor configured for carrying out the steps of any of the above methods. The wireless communication device may be either of a non-AP MLD and an AP MLD.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions;

FIG. 2 illustrates a Basic variant Multi-Link Element as specified in document IEEE P802.11be/D1.1;

FIG. 3a illustrates the format of an EML Control field forming an EML OM Notification frame used to activate or deactivate an EML OM as defined in the D1.1 standard;

FIG. 3b illustrates an alternative format of the EML Control field;

FIG. 4 schematically illustrates an exemplary sequence of EML OM Management frames for activating or deactivating an EML Operating Mode as specified in document IEEE P802.11be/D1.1;

FIGS. 5a to 5c illustrate alternative formats of an EML Control field according to embodiments of the invention;

FIGS. 6a and 6b schematically illustrate an EML OM Management to refuse a requested activation or deactivation of an EML Operating Mode, according to embodiments of the invention;

FIGS. 7a and 7b schematically illustrate an EML OM Management where the AP MLD spontaneously suggests an activation of an EML OM, according to embodiments of the invention;

FIG. 8 schematically illustrates an EML OM Management where the AP MLD spontaneously suggests a deactivation of a currently active EML OM, according to embodiments of the invention;

FIG. 9 schematically illustrates an EML OM Management where the AP MLD spontaneously suggests a modification of a currently active EML OM, according to embodiments of the invention;

FIG. 10 schematically illustrates an EML OM Management where the AP MLD is solicited to indicate which set of links is to be used for an EML OM to activate, according to embodiments of the invention;

FIG. 11 schematically illustrates an EMLMR capable architecture for an MLD to implement embodiments of the invention; and

FIG. 12 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi (RTM) networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D1.1 of July 2021, introduce the Multi-Link Operation (MLO) when it comes to MAC layer operation. The MLO allows multi-link devices to establish or setup multiple links and operate them simultaneously.

A Multi-Link Device (MLD) is a logical entity and has more than one affiliated station (STA) and has a single medium access control (MAC) service access point (SAP) to logical link control (LLC), which includes one MAC data service. An Access Point Multi-Link Device (or AP MLD) then corresponds to a MLD where each station (STA) affiliated with the MLD is an AP, hence referred to as “affiliated AP”. A non-Access Point Multi-Link Device (or non-AP MLD) corresponds to a MLD where each station (STA) affiliated with the MLD is a non-AP STA, referred to as “affiliated non-AP station”. Depending on the literature, “multilink device”, “ML Device” (MLD), “multilink logical entity”, “ML logical entity” (MLE), “multilink set” and “ML set” are synonyms to designate the same type of ML Device.

Multiple affiliated non-AP stations of a non-AP MLD can then setup communication links with multiple affiliated APs of an AP MLD, hence forming a multi-link channel.

The links established for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP stations operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated stations but not necessary a number equal to its number of affiliated stations. In particular, a non-AP MLD may operate with a number of affiliated stations greater than its number of radios (which can even be reduced to a single one).

Several Enhanced Multi-Link Operating Modes (or EML OMs in short) can be defined from this physical architecture. P802.11be/D1.1 currently specifies two EML OM for a non-AP MLD.

A first one, so-called EMLSR (Enhanced Multi-Link Single Radio) mode, is an operating mode wherein a non-AP MLD is able to listen to a set of links (so-called EMLSR links) simultaneously for the reception of initial control frames (e.g. MU-RTS, BSRP) transmitted by an AP MLD and can then perform data frames exchange with the AP MLD over one link at a time (usually corresponding to the link wherein the initial control frame has been emitted).

A second one, so-called EMLMR (Enhanced Multi-Link Multi-Radio) mode, is an operating mode wherein a non-AP MLD is able to aggregate some physical resources of its different radios used on different links (so-called EMLMR links) in order to transmit or receive data up to a pre-defined number of supported Rx/Tx spatial streams, which number being greater than the number of supported Rx/Tx spatial streams of each radio.

Each non-AP MLD may support either no EML operating mode, only the EMLSR operating mode, only the EMLMR mode or both.

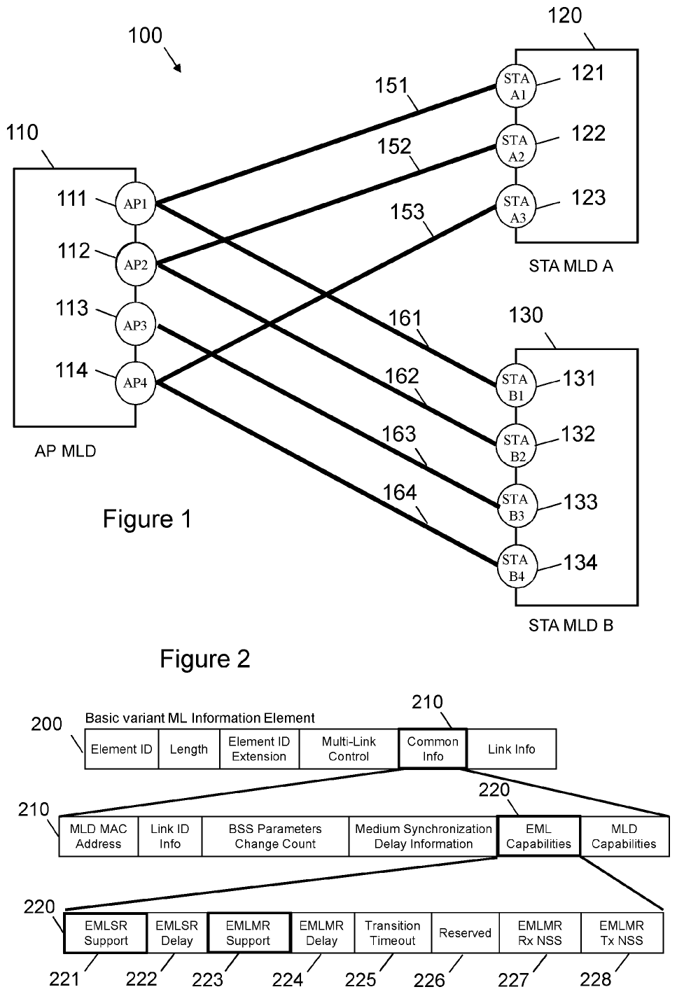

FIG. 1 illustrates a typical 802.11 network environment involving ML transmissions in which the present invention may be implemented.

Wireless communication network 100 involves an AP MLD 110 and two non-AP MLDs 120 and 130. Of course, another number of non-AP MLDs registering to the AP MLD 110 and then exchanging frames with it may be contemplated.

AP MLD 110 has multiple affiliated APs, four affiliated APs 111, 112, 113 and 114 (also referenced AP1, AP2, AP3, AP4 respectively) in the exemplary Figure, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP stations, each of which behaves as an 802.11 non-AP station in a BSS (managed by an affiliated AP 111, 112, 113, 114) to which it registers. In the exemplary Figure, three non-AP STAs 121, 122 and 123 (also referenced A1, A2, A3 respectively) are affiliated with non-AP MLD 120 and four non-AP STAs 131, 132, 133 and 134 (also referenced B1, B2, B3 and B4 respectively) are affiliated with non-AP MLD 130.

For illustrative purpose, non-AP MLDs 120 and 130 are multi-radio non-AP MLDs. For example, AP 111 is set to operate on channel 10 corresponding to an operating 20 MHz channel in the 2.4 GHz frequency band, AP 112 is set to operate on channel 36-40 corresponding to an operating 40 MHz channel in the 5 GHz frequency band, AP 113 is set to operate on channel 149-153 corresponding to an operating 40 MHz channel in the 5 GHz frequency band too, and AP 114 is set to operate on channel 301 corresponding to an operating 160 MHz channel in the 6 GHz frequency band. In this example, the affiliate stations operate on various frequency bands.

Each affiliated AP offers a link towards the AP MLD 110 to the affiliated non-AP stations. Hence, the links for each non-AP MLD can be merely identified with the identifiers of the respective affiliated APs. In this context, each of the affiliated APs 111-114 can be identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP station of the non-AP MLD. Each link enables individual channel access and frame exchanges between the non-AP MLD and the AP MLD based on supported capabilities exchanged during association.

The discovery phase is referred below to as ML discovery procedure, and the multi-link setup phase (or association phase) is referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate setup links between its own affiliated non-AP stations and some of the discovered affiliated APs and to request the AP MLD 110 to set up these links, which may be accepted or refused by the AP MLD. If accepted, the non-AP MLD is provided with an Association Identifier (AID) by the AP MLD, which AID is used by the affiliated non-APs of the non-AP MLD to wirelessly communicate over the multiple links (communication channels) with their corresponding affiliated APs.

For illustrative purpose, in wireless communication network 100, three candidate setup links have been requested by non-AP MLD 120 to AP MLD 110 and have been accepted by AP MLD 110: a first link 151 between affiliated AP 111 (AP1) and affiliated non-AP STA 121 (A1), a second link 152 between affiliated AP 112 (AP2) and affiliated non-AP STA 122 (A2), and a third link 153 between affiliated AP 114 (AP4) and affiliated non-AP STA 123 (A3).

Similarly, four candidate setup links have been requested by multi-radio non-AP MLD 130 to AP MLD 110 and have been accepted by AP MLD 110: a first link 161 between affiliated AP 111 (AP1) and affiliated non-AP STA 131 (B1), a second link 162 between affiliated AP 112 (AP2) and affiliated non-AP STA 132 (B2), a third link 163 between affiliated AP 113 (AP3) and affiliated non-AP STA 133 (B3) and a fourth link 164 between affiliated AP 114 (AP4) and affiliated non-AP STA 134 (B4).

During the ML setup procedure, the non-AP MLDs declare part or all of their capabilities. For instance, they may declare their EMLSR capability and/or EMLMR capability. As described below, appropriate fields are provided in the management frames, for instance in the ML Association Request frame.

The management frames exchanged during the ML discovery and ML setup procedures contains new multi-link (ML) Information Elements specific to the Multi-Link Operation (MLO), referred to as Multi-Link elements. In particular, the ML Association request frame exchanged during the setup procedure is an Association Request frame as defined in 802.11ax (for example IEEE P802.11ax/D8.0 of October 2020) augmented with a Basic variant Multi-Link element 200 as illustrated in FIG. 2 and defined in IEEE P802.11be/D1.1 in which the non-AP MLD can declare its EMLSR/EMLMR capabilities.

The 802.11ax fields of the Association Request frame are used in a conventional way, for instance to request the association of an affiliated non-AP station (e.g. B1 131) with an addressee affiliated AP (e.g. AP1 111). This defines a requested setup link defined between the affiliated non-AP station and an affiliated AP addressee of the ML Association Request frame.

MAC header of frame 221 sets the transmitting address TA to the MAC address of the affiliated non-AP station and the destination address RA to the MAC address of the destination affiliated AP.

Basic variant Multi-Link element 200 includes Element ID field, Length field (enabling to know the presence or not of the optional fields as well as the number of Per-STA profiles in field), Element ID Extension field, Multi-Link Control field, optional Common Info field 310 and optional Link Info field.

Multi-Link Control field includes a Presence Bitmap subfield indicating which subfields are included in Common Info field 210.

According to the values specified in the Presence Bitmap subfield, Common Info field 10 includes optionally a MLD MAC Address subfield, a Link ID Info subfield, a BSS Parameters Change Count subfield, a Medium Synchronization Delay Information subfield, an EML Capabilities subfield 220 and a MLD Capabilities subfield.

EML Capabilities subfield 220 is used to declare the non-AP MLD's capabilities in terms of enhanced multi-link, in particular regarding EMLSR and EMLMR. It includes an EMLSR Support subfield 221, an EMLSR Delay subfield 222, an EMLMR Support subfield 223, an EMLMR Delay subfield 224, a Transition Timeout subfield 225, a Reserved subfield 226, an EMLMR Rx NSS subfield 227 and an EMLMR Tx NSS subfield 228.

EMLSR Support subfield 221, preferably a one-bit subfield, indicates support of the EMLSR operation for the MLD. EMLSR Support field 251 is set to 1 if the MLD supports the EMLSR operation; otherwise it is set to 0. EMLSR Delay subfield 222 indicates the MAC padding duration of the Padding field of the initial Control frame.

EMLMR Support subfield 223, preferably a one-bit subfield, indicates support of the EMLMR operation for the MLD. EMLMR Support field is set to 1 if the MLD supports the EMLMR operation; otherwise it is set to 0. EMLMR Delay subfield 224 indicates the minimum padding duration required for a non-AP MLD for EMLMR link switch when operating in EMLMR mode.

Transition Timeout subfield 225 indicates the maximum timeout value for activating (or initiating) or deactivation (or terminating) an EML OM, from the EML Operating Mode Notification frame exchange.

EMLMR Rx NSS and EMLMR Tx NSS subfields 227, 228 indicate the maximum receive and transmit Nss (Number of spatial streams) respectively, that are supported by the non-AP MLD in the EMLMR mode.

More details on these fields can be found in the D1.1 standard.

In a scenario, non-AP MLDs 120 and 130 support both the EMLSR operating mode and the EMLMR mode. Hence, during the ML setup procedure, they transmit a ML Association request frame for which the EMLSR Support subfield 221 and the EMLMR Support subfield 223 of the EML Capabilities subfield 220 of the Common Info field 210 of the Basic Variant Multi-Link element 200 are both set to 1.

Once the links have been setup and capabilities been exchanged, the non-AP MLDs 120, 130 perform Multi-Link Operation (MLO) with their associated AP MLD 110. An example of MLO is an exchange of frames (uplink and/or downlink communication).

During MLO, each of the non-AP MLDs may activate the EMLSR or EMLMR mode if appropriate. To activate one of the EML OM, each of the non-AP MLDs sends an EHT Action frame to AP MLD 110, typically an EML Operating Mode Notification frame with its EMLMR Mode subfield or EMLSR Mode subfield equal to 1. The EML OM frame is identified by an EHT Action field (in the octet immediately after the Category field) set to 1.

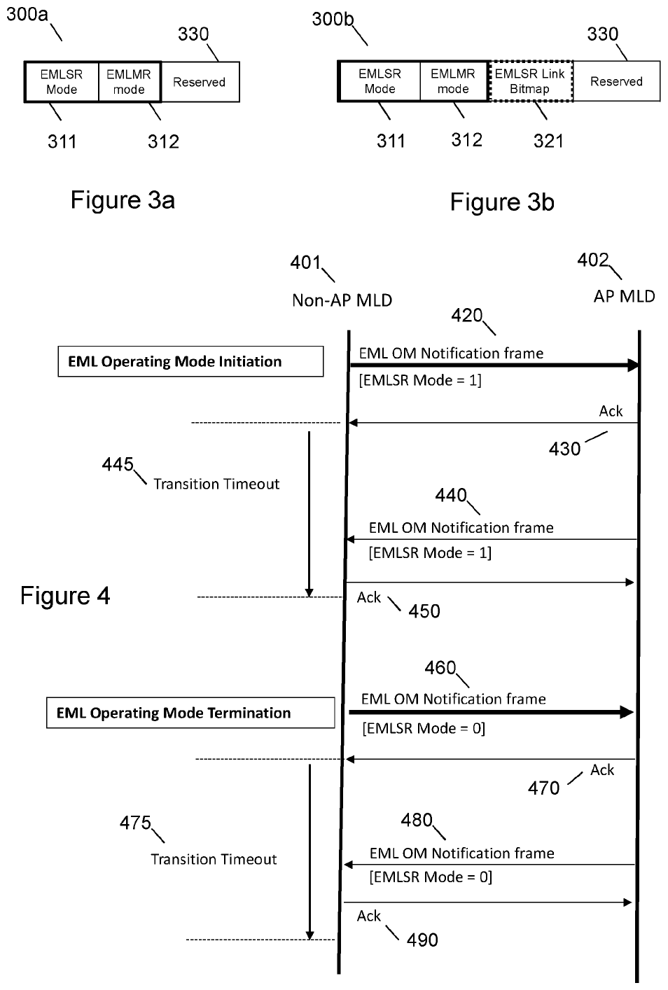

FIG. 3a illustrates the format of the EML Control field forming the EML OM Notification frame used to activate or deactivate an EML OM as defined in the D1.1 standard.

The 8-bit EML Control field 300a of the EML OM frame includes a one-bit EMLSR Mode subfield 311, a one-bit EMLMR subfield 312 and 6 reserved bits 330.

A non-AP MLD supporting EMLSR operations (as declared in its EML capabilities) sets the EMLSR Mode subfield 311 to 1 to request an activation of the EMLSR mode. This indicates that the non-AP MLD is going to operate in EMLSR mode.

The non-AP MLD supporting EMLSR operations (as declared in its EML capabilities) sets the EMLSR Mode subfield 311 to 0 to indicate that it does no longer intend to operate in EMLSR mode.

The EMLSR Mode subfield 311 is set to 0 for all non-AP MLDs that do not support EMLSR operations.

Similarly, a non-AP MLD supporting EMLMR operations (as declared in its EML capabilities) sets the EMLMR Mode subfield 312 to 1 to request an activation of the EMLMR mode. This indicates that the non-AP MLD is going to operate in EMLMR mode.

The non-AP MLD supporting EMLMR operations (as declared in its EML capabilities) sets the EMLMR Mode subfield 312 to 0 to indicate that it does no longer intend to operate in EMLMR mode.

The EMLMR Mode subfield 312 is set to 0 for all non-AP MLDs that do not support EMLMR operations.

An exclusive usage of the EMLMR and EMLSR modes further requires that the EMLSR Mode subfield 311 (respectively EMLMR Mode subfield 312) is set to 0 for all non-AP MLDs that have set the EMLMR (resp. EMLSR Mode subfield 311) Mode subfield 312 to 1.

As described below, an AP MLD sets the EMLSR Mode subfield 311 and EMLMR Mode subfield 312 to the value obtained from a received EML Operating Mode Notification frame.

FIG. 3b illustrates an alternative format of the EML Control field forming an EML OM Notification frame used to activate or deactivate an EML operating mode.

This alternative format adds EMLSR Link Bitmap field 321 to above EMLSR Mode subfield 311 and EMLMR Mode subfield 312. Reserved subfield 330 includes the remaining unused bits.

EMLSR Link Bitmap subfield 321 is typically coded over 8 or 16 bits and indicates a subset of the enabled links that is used by the non-AP MLD in the EMLSR mode. For example, non-AP MLD A 120 may designate links 151 and 152 (and thus not link 153) for the EMLSR mode.

Bit at position i in the EMLSR Link Bitmap subfield 321 corresponds to the link with the Link ID equal to i. It is set to 1 to indicate that the link is used by the non-AP MLD for the EMLSR mode and is a member of the EMLSR links; otherwise the bit is set to 0.

FIG. 4 schematically illustrates an exemplary sequence of frames for activating or deactivating an EML Operating Mode as specified in document IEEE P802.11be/D1.1. The activation of an EML OM by a non-AP MLD is referred to as EML OM Initiation. The deactivation of an EML OM by a non-AP MLD is referred to as EML OM Termination. As shown in the Figure, such activation or deactivation of an EML OM is always initiated by a non-AP MLD.

When a non-AP MLD 401 supporting an EML OM (EMLSR/EMLMR mode) intends to operate in one of the EML OMs, a STA affiliated with the non-AP MLD 401 transmits an EML OM Notification frame 420 (FIG. 3a) to an AP affiliated with AP MLD 402. If non-AP MLD 401 intends to activate the EMLSR mode, it sets the EMLSR Mode subfield 311 of the EML Control field 300a of frame 420 to 1. If it intends to activate the EMLMR mode, it sets the EMLMR Mode subfield 312 of the EML Control field 300a of frame 420 to 1. In FIG. 4, EMLSR Mode subfield is set to 1 to seek for an activation of the EMLSR mode.

The AP affiliated with AP MLD 402 that receives the EML OM Notification frame 420 acknowledges the received frame 420 by sending an acknowledgement 430 at MAC level. After successful transmission of the EML OM Notification frame 420 (i.e. after the acknowledgment 430 is sent and received), non-AP STA 401 and AP MLD 402 initialize a Transition Timeout timer 445 with the Transition Timeout subfield value 225 included in the EML Capabilities subfield 220 of the Basic variant Multi-Link element 200 received from the AP MLD during the ML setup procedure.

The Transition Timeout timer 445 starts counting down from the end of the PPDU containing the acknowledgement 430 of the EML OM Notification frame 420. The Transition Timeout defines the maximum time to receive an EML OM Notification frame 440 from the AP MLD before entering the requested OM.

AP MLD 402 may then send an EML OM Notification frame 440 to non-AP STA 401 with an EML Control field set to the same values as EML Control field 300a in the received EML OM Notification frame 420. The transmission of the EML OM Notification frame 440 is made before Transition Timeout timer 445 expires.

The EML OM Notification frame 440 is acknowledged (acknowledgement 450) by non-AP MLD 401.

The EML OM requested by non-AP STA 401 is activated either at the expiration of Transition Timeout timer 445 or after a successful reception of the EML OM Notification frame 440 from AP MLD 420.

Multi-Link Operation (MLO) is performed using the activated EML OM (EMLSR in the example), for example to exchange frames (uplink and/or downlink communication).

When non-AP MLD 401 supporting an EML operating mode (EMLSR/EMLMR) intends to disable the EML mode, a STA affiliated with non-AP MLD 401 transmits an EML OM Notification frame 460 (FIG. 3a) to an AP affiliated with AP MLD 402. If non-AP MLD 401 intends to disable the EMLSR mode, it sets the EMLSR Mode subfield 311 of the EML Control field 300a of frame 460 to 0. If non-AP MLD 401 intends to disable the EMLMR mode, it sets the EMLMR Mode subfield 312 of the EML Control field 300a of frame 460 to 0. In the example of FIG. 4, EMLSR Mode subfield is set to 0 to deactivate a currently active EMLSR mode.

The AP affiliated with the AP MLD 402 that receives the EML OM Notification frame 460 acknowledges the received frame 460 by sending an acknowledgement 470 at MAC level. After successful transmission of the EML OM Notification frame 460 (i.e. after the acknowledgment 470 is sent and received), non-AP STA 401 and the AP MLD 402 initialize a Transition Timeout timer 475 with the Transition Timeout subfield value 225 included in the EML Capabilities subfield 220 of the Basic variant Multi-Link element 200 received from the AP MLD during the ML setup procedure.

The Transition Timeout timer starts counting down from the end of the PPDU containing the acknowledgement 470 of the EML OM Notification frame 460.

AP MLD 402 may send an EML OM Notification frame 480 to non-AP STA 401 with an EML Control field set to the same values as EML Control field 300a in the received EML OM Notification frame 460. The transmission of the EML OM Notification frame 480 is made before Transition Timeout timer 475 expires.

The EML OM Notification frame 480 is acknowledged (acknowledgement 490) by non-AP MLD 401.

The EML OM requested by non-AP STA 401 is disabled either at the expiration of Transition Timeout timer 475 or after a successful reception of the EML OM Notification frame 480 from AP MLD 420.

The same sequence as the one of FIG. 4 can be used with the EML Control field format of FIG. 3b. In that case, the activation of an EMLSR mode is made using the EMLSR links specified in EMLSR Link Bitmap subfield 321.

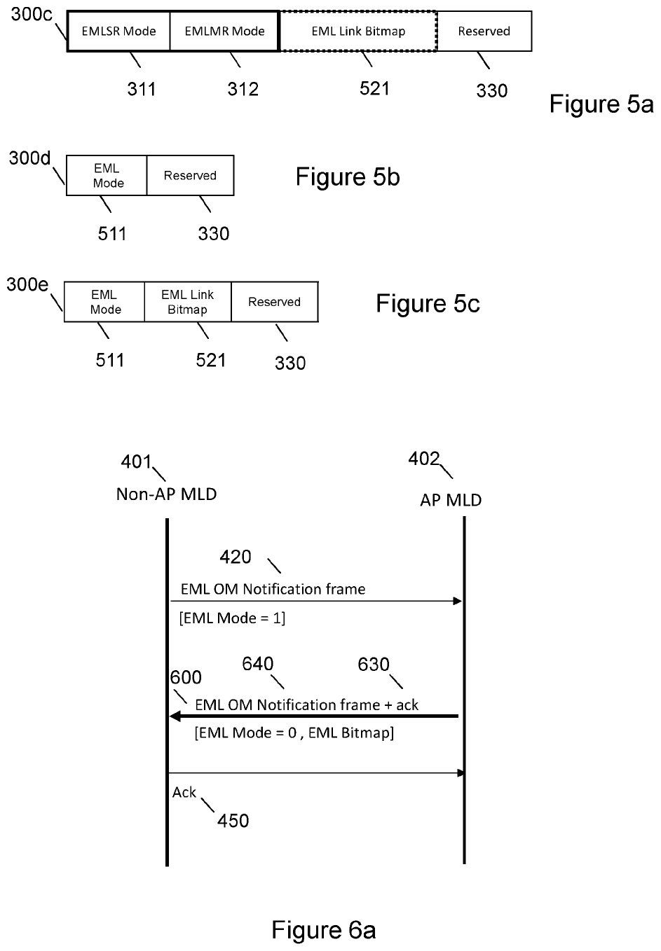

The invention may contemplate using the same subfield 321 to indicate which EMLMR links to be used when activating the EMLMR mode (EMLMR Mode subfield 312 set to 1 in frame 420). Subfield 321 may thus be renamed EML Link Bitmap subfield 521 as shown in FIG. 5a.

Embodiments of the invention seeking to reduce signalling costs may use variants to the above EML Control field formats. They are illustrated in FIGS. 5b and 5c.

As shown in these Figures, EMLSR Mode subfield 311 and EMLMR Mode subfield 312 are merged into a single one-bit subfield 511.

This is made possible thanks to the capability declaration exchanged from non-AP MLD 401 acting as a requesting MLD to AP MLD 402 acting as a requested MLD, declaring that the requesting MLD supports Enhanced Multi-Link, EML, operations. As mentioned above, the capability declaration is conveyed in an EML Capabilities field 220 having a first EMLSR Support subfield 221 to declare support of EMLSR operations and a second EMLMR Support subfield 223 to declare support of EMLMR operations. One only of the two subfields may be enabled in which case the single one-bit subfield 511, namely EML Mode subfield, inherits from the declared supported mode (either EMLSR or EMLMR): EML Mode subfield indicates the activation or deactivation of the sole EML OM supported as declared during the association procedure. This applies for instance when the requesting non-AP MLD cannot support both the EMLSR Mode and the EMLMR Mode, hence declare only one of the two modes.

EML Control field 300 of the exchanged EML OM frame 420, 440, 460, 480 requesting an activation or deactivation of an EML OM includes one one-bit EML Mode subfield 511 (FIG. 5b) and optionally a ML Link Bitmap subfield 521 (FIG. 5c).

Non-AP MLD 401 declaring a support of the EMLSR mode only sets EML Mode subfield 511 to 1 to implicitly indicate an activation of the EMLSR mode and thus that non-AP MLD 401 is going to operate in the EMLSR mode. On the other hand, non-AP MLD 401 sets EML Mode subfield 511 to 0 to indicate a deactivation of the current EMLSR mode, and thus that non-AP MLD 401 does no longer operate in the EMLSR mode.

Similarly, non-AP MLD 401 declaring it supports the EMLMR mode only sets EML Mode subfield 511 to 1 to implicitly indicate an activation of the EMLMR mode and thus that non-AP MLD 401 is going to operate in the EMLMR mode. On the other hand, non-AP MLD 401 sets EML Mode subfield 511 to 0 to indicate a deactivation of the current EMLMR mode, and thus that the non-AP MLD does no longer operate in the EMLMR mode.

Upon sending or receiving the requesting EML OM Notification frame 420 or 460 or the responding EML OM Notification frame 440 or 480, non-AP MLD 401 and AP MLD 402 activate or deactivate an EML OM depending on the combination of the EML Capabilities field 220 and the EML Mode subfield 511. For example, in case the one-bit EML Mode subfield 511 of the requesting EML OM Notification frame 420 is set to a first value (value 1), the MLD activates the EMLSR mode with the other MLD if the capability declares non-AP MLD 401 supports EMLSR operations or activates the EMLMR mode with the other MLD if the capability declares non-AP MLD 401 supports EMLMR operations.

Similarly, the MLD can determine which mode is supported by the non-AP MLD before deactivating a current EML OM in response to a requesting EML OM Notification frame 460 requesting a deactivation using EML Mode subfield 511. However, due to the single mode in the mode support declaration, such a requesting frame may merely request the termination of the sole currently active EML OM. Therefore, it may be considered deactivating a current active EML OM when the one-bit EML Mode subfield field is set to a second value (value 0) different from the first value.

FIG. 5c illustrates the case where the requesting EML OM Notification frame, e.g. frame 420, includes an EML Link Bitmap field 521 signaling a set of links for activating the EMLSR or EMLMR OM between the two MLDs.

For instance, EML Link Bitmap subfield 521 indicates the subset of the enabled EMLSR links that is used by non-AP MLD 401 if the latter supports (only) the EMLSR mode. In such a case, the bit at position i of EML Link Bitmap subfield 521 corresponds to the link with the Link ID equal to i and the bit is set to 1 to indicate that the corresponding link is used by non-AP MLD 401 for the EMLSR mode and is thus a member of the EMLSR links; otherwise the bit is set to 0. Similarly, EML Link Bitmap subfield 521 indicates the subset of the enabled EMLMR links that is used by non-AP MLD 401 if the latter supports (only) the EMLMR mode. In such a case, the bit at position i of EML Link Bitmap subfield 521 corresponds to the link with the Link ID equal to i and the bit is set to 1 to indicate that the corresponding link is used by non-AP MLD 401 for the EMLMR mode and is thus a member of the EMLMR links; otherwise the bit is set to 0.

Other embodiments of the invention seeking to reduce signalling costs are directed to a simplification of the EML OM Notification frames 460, 480 when link bitmaps (EMLSR or EML Link Bitmap subfield 321/521) are provided upon activating the EML OMs.

In a scenario, a first requesting EML OM Notification frame 420 requesting an activation of an EML OM (EMLSR mode or EMLMR mode) is exchanged from non-AP MLD 401 acting as a requesting MLD to AP MLD 402 acting as a requested MLD, wherein the first requesting EML OM Notification frame includes an EMLSR or EML Link Bitmap field 321/521 (FIG. 3b or 5a or 5c) signaling a set of links to be used in the EML OM to activate. Data are then exchanged between the two MLDs using the activated EML OM. A second requesting EML OM Notification frame 460 requesting a deactivation of the activated EML OM is next exchanged from non-AP MLD 401 to AP MLD 402. In these specific embodiments, the second requesting EML OM Notification frame 460 is deprived of any link bitmap signaling a set of links, i.e. deprived of an EMLSR or EML Link Bitmap field 321/521.

In other words, when EML Mode subfield 511 is set to 0, i.e. to deactivate an activated EML Mode, or when both EMLSR Mode subfield 311 and EMLMR mode subfield 312 are set to 0, EML Link Bitmap subfield 521 may not be included in the EML Control field.

Indeed, for a deactivation of an EML OM, the set of links is useless. Hence, thanks the asymmetry between the successive activation and deactivation requesting frames 420 and 460, signaling bits for the link bitmap can be saved (at the deactivation requesting time).

In the current version of the IEEE P802.11be/D1.1, the process of activating or deactivating an EML OM is initiated/triggered by non-AP MLD 401. AP MLD 402 only replies with a responding EML OM Notification frame 440, 480 which is similar to the requesting EML OM Notification frame 420, 460. In other words, AP MLD 402 can only accept what non-AP MLD 401 requests. Although the decision by non-AP MLD 401 is probably optimum given non-AP MLD's constraints and knowledge of the network, this is not a satisfactory situation because the AP MLD may also have other constraints or knowledge of the network that could require another decision regarding the EML OMs. An AP MLD may for instance be aware of a quantity of data to be sent in downlink intended to non-AP stations, of current interferences in the BSS or of NSTR constraints for a specific AP such as soft-AP.

The inventors thus have contemplated providing more options to the AP MLD to contribute to the EML OM management (activation, deactivation, and even modification).

Taking advantage of the responding EML OM Notification frames 440, 480, embodiments provide the ability to the AP MLD of refusing a requested activation or deactivation of an EML OM. This means for the AP MLD, responsive to receiving, from a non-AP MLD, a requesting EML OM Notification frame 420, 460 requesting an activation or deactivation of an EML OM, the ability to send, to the non-AP MLD, a responding EML OM Notification frame refusing the activation or deactivation.

In embodiments, the signalling of the refusing may merely rely on using the opposite value in the EML/EMLSR/EMLMR Mode subfield 511/311/312 (depending on the format used) as the value indicated in the requesting EML OM Notification frame.

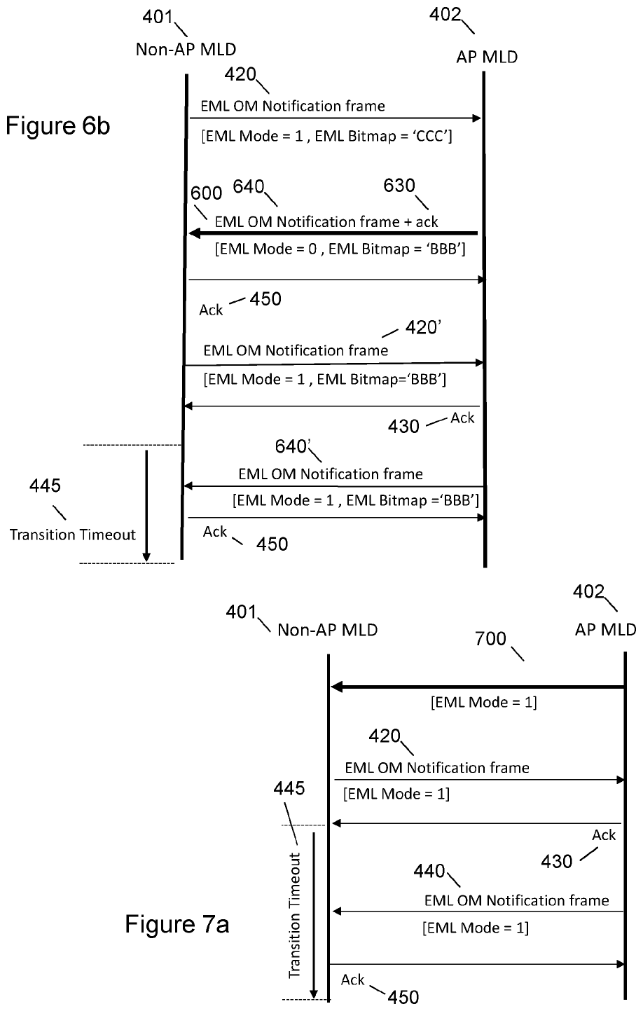

FIG. 6a schematically illustrates such embodiments in an exemplary sequence of frames for activating an EML OM. Of course, a similar approach may be used when refusing a deactivation of an EML OM.

First, non-AP MLD 401 supporting EML operations (either EMLSR or EMLMR or both) sends, to AP MLD 402, a requesting EML OM Notification frame 420 requesting an activation of an EML OM. This is a step similar as described above, based for example of the EML Control field format of FIG. 3a or 5b, meaning that EML Mode subfield 511 or EMLSR Mode subfield 311 or EMLMR Mode subfield 312 is set to 1 for activating an EML OM, or these subfields are set to 0 for deactivating a current EML OM.

In response to receiving such frame, AP MLD 402 determines whether the solicited request (activation in the example, but applicable to deactivation) is acceptable from its own point of view. The deciding process at the AP MLD is not a key aspect of the present embodiments. Hence, any approach to take a decision can be considered. If the solicited request is acceptable, conventional process (see FIG. 4) can be conducted.

On the other hand, in case AP MLD 402 does not agree with the request, it can refuse it by preparing and sending a refusing EML OM Notification frame 640 using the same EML Control field format. EML OM Notification frame 640 from AP MLD 402 is a “refusing” frame because it includes an EML Mode subfield 511/311/312 set to an opposite value (e.g. 0) for the requested EML OM as the corresponding EML Mode subfield in the requesting EML OM Notification frame 620.

Thanks to this opposite value, non-AP MLD 401 receiving, from AP MLD 402, the responding EML OM Notification frame 620 is early aware of the refusal from AP MLD 402.

As shown in the Figure, the responding EML OM Notification frame 640 is preferably included in the same Physical Protocol Data Unit, PPDU 600, as the (MAC) acknowledgment 630 to the requesting EML OM Notification frame 620. Indeed, by early determining the AP MLD's refusal, non-AP MLD 401 can prevent its Transition Timeout timer 445, 475 to be started and thus avoid an automatic activation of the requested EML OM although a refusal thereof is pending. Non-AP MLD 401 and AP MLD 402 therefore not start their local Transition Timeout timer upon sending (for AP MLD) or receiving (for non-AP MLD) an acknowledgment 630 to the requesting EML OM Notification frame 420 that is included in the same Physical Protocol Data Unit, PPDU 600, as the responding EML OM Notification frame 640 refusing the activation. This action interrupts the on-going EML OM initiation.

Non-AP 401 can next send an acknowledgment 450 to frame 640 refusing the activation.

FIG. 6b illustrates a variant wherein a link bitmap is provided in the EML OM Notification frames, still applicable to deactivations although it is described below with respect to a request to activate an EML OM. Any EML Control field format 300b (FIG. 3b), 300c (FIG. 5a), 300e (FIG. 5c) can be used.

First, non-AP MLD 401 supporting EML operations (either EMLSR or EMLMR or both) still sends, to AP MLD 402, a requesting EML OM Notification frame 420 requesting an activation of an EML OM, such frame 420 including a link bitmap 321/521 indicating links to be used for the EML OM to activate. In this example, link bitmap “CCC” is specified.

In response to receiving such frame, AP MLD 402 determines whether the solicited request (activation in the example, but applicable to deactivation) is acceptable from its own point of view. The deciding process at the AP MLD is not a key aspect of the present embodiments. Hence, any approach to take a decision can be considered. In particular, a decision may be taken with respect to the action of activating an EML OM and/or with respect to the set of links that is signaled in link bitmap “CCC” for the activation.

If the solicited request is acceptable, conventional process (see FIG. 4) can be conducted.

On the other hand, in case AP MLD 402 does not agree with the request, it can refuse it by preparing and sending a refusing EML OM Notification frame 640 using the same EML Control field format. EML OM Notification frame 640 from AP MLD 402 is a “refusing” frame because it includes an EML Mode subfield 511/311/312 set to an opposite value (e.g. 0) for the requested EML OM as the corresponding EML Mode subfield in the requesting EML OM Notification frame 620.

Thanks to this opposite value, non-AP MLD 401 receiving, from AP MLD 402, the responding EML OM Notification frame 620 is early aware of the refusal from AP MLD 402.

In addition, should the decision of the AP MLD to refuse be based on the fact the links proposed in the link bitmap “CCC” are not considered as being the appropriate ones, AP MLD 402 may make a counter-proposal for the set of links. In this respect, it includes, in the responding EML OM Notification frame 640, a Link Bitmap field 321/521 signaling a proposed set of links for activating the EML OM between the two MLDs. The proposed links may be links for which the AP MLD is ready to accept an activation of the EML OM. Any methodology to determine such “acceptable” set of links may be envisioned. In the example of the Figure, the proposed set of alternative links is indicated as link bitmap “BBB” that is indeed different from the first set of links “CCC” signaled in the requesting EML OM Notification 420.

As above, the responding EML OM Notification frame 640 is preferably included in the same Physical Protocol Data Unit, PPDU 600, as the (MAC) acknowledgment 630 to the requesting EML OM Notification frame 620. This is still to prevent the MLD's Transition Timeout timers 445, 475 to be started and thus to avoid an automatic activation of the requested EML OM although a refusal thereof is pending.

Non-AP MLD 401 can next send an acknowledgment 450 to frame 640 refusing the activation.

Being aware of the set of links “BBB” AP MLD 402 is ready to accept, non-AP MLD 401 can decide to send, to AP MLD 402, a new requesting EML OM Notification frame 420′ requesting an activation of an EML OM, such frame 420 including, this time, the proposed set of links “BBB”.

As this request will be accepted by AP MLD 402, the subsequent steps are conventional steps with an acknowledgment 430 starting the Transition Timeout timer 445, an EML OM Notification frame 640′ identical to the requesting EML OM Notification frame 420′ and a final acknowledgment 450.

This embodiment of FIG. 6b shows a first illustrative level of the AP MLD's ability to make proposals or suggestions to non-AP MLDs for the EML OM management.

Embodiments of the invention also provide the AP MLD with abilities to suggest, to the non-AP MLDs, activations and deactivations of EML OMs in line with the EML capabilities of those non-AP MLDs as declared during the ML setup procedure. Such suggestions sharply contrast with the D1.1 standard where only the non-AP MLDs initiate the EML OM activation/deactivation procedure.

These embodiments rely on an EML OM Notification frame, sent by the AP MLD to a non-AP MLD, defining (i.e. including or notifying or signaling) a proposal from the AP MLD to activate or deactivate or modify an EML OM. As this frame is a mere suggestion or proposal to take an EML OM management action, it is spontaneously sent by the AP MLD at its own initiative. By spontaneous, it is meant without any prompt from the non-AP MLD: the non-AP MLD thus receives, from the AP MLD, a-spontaneous-EML OM Notification frame defining a proposal from the AP MLD to activate or deactivate or modify an EML OM. For instance, this EML OM Notification frame precedes a requesting EML OM Notifications frame 420 from the non-AP MLD.

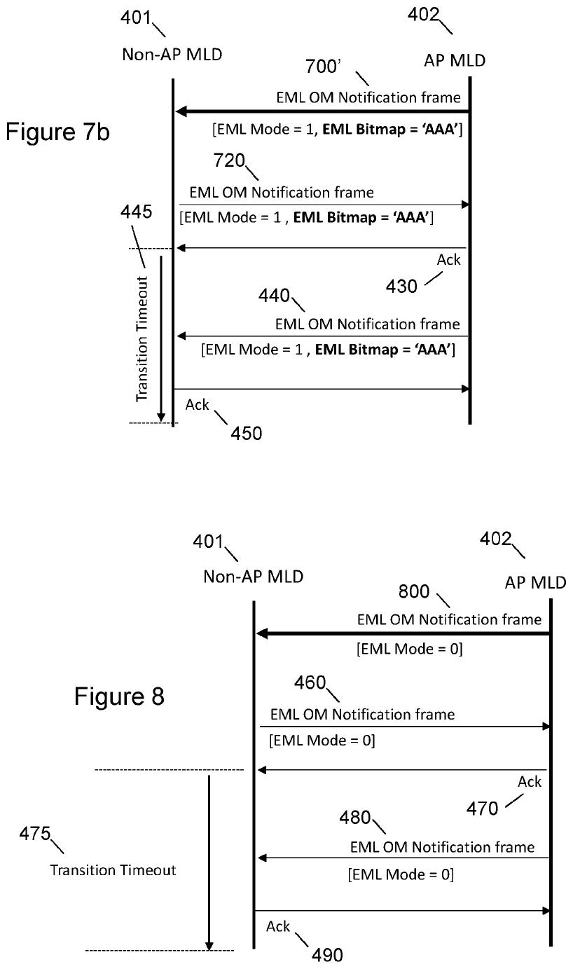

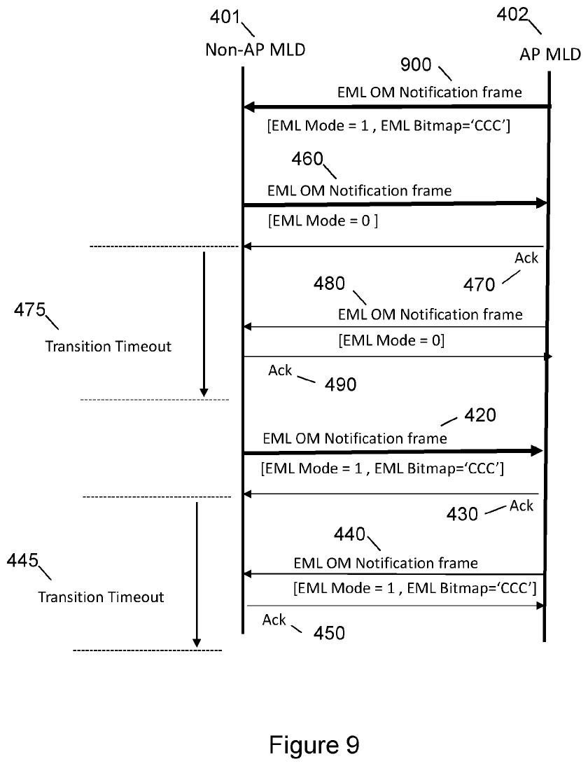

These embodiments are illustrated by FIGS. 7a and 7b with respect to the activation of an EML OM, by FIG. 8 with respect to the deactivation of a currently active EML OM, and by FIG. 9 with respect to the modification of a currently active EML OM.

The AP MLD is aware of which non-AP MLD supports EML operations, in particular the EMLSR mode and/or the EMLMR mode, thanks to the EML Capabilities exchanged during the association of the non-AP MLD to the AP MLD.

As shown in FIG. 7a, an EML OM Initiation Proposal from the AP MLD includes the sending, by AP MLD 402 to a non-AP MLD (e.g. non-AP MLD 401), of EML OM Notification frame 700 proposing to activate an EML OM. Any of the EML Control field formats of FIGS. 3a and 5b can be used. As being a proposal for an EML OM activation, EML OM Notification frame 700 has its EML Mode subfield 511 or EMLSR Mode subfield 311 or EMLMR Mode subfield 312 set to 1 for activating an EML OM which is supported by the targeted non-AP MLD.

The sending may be responsive to a triggering event detected locally, for example a change in network conditions that leads the AP MLD to suggest the EMLSR and/or EMLMR modes with some or all of its associated non-AP MLDs. The triggering event excludes the reception of an EML OM Notification frame requesting the same activation, from the non-AP MLD.

Because EML OM Notification frame 700 is received by non-AP MLD 401 without prior sending of an EML OM Notification frame, it is considered by non-AP MLD 401 as being a suggestion or proposal from AP MLD 402. Therefore, non-AP MLD 401 can evaluate the opportunity to follow the AP MLD 402′s suggestion/proposal and hence to request an activation of an EML OM as suggested (for example to activate the EMLSR mode if AP MLD 402 suggests activating such mode).

Once non-AP MLD 401 evaluates positively the opportunity, it sends, in response to the received (suggesting) frame 700, to AP MLD 402, a requesting EML OM Notification frame 420 requesting an activation of the EML OM, then starting any procedure processing such frame 420 (e.g. the conventional process of FIG. 4 or a process with a refusal as in FIG. 6a or 6b). In the example of the Figure, the subsequent steps are conventional steps with an acknowledgment 430 starting the Transition Timeout timer 445 (triggering an actual activation of the requested EML OM), an EML OM Notification frame 440 identical to the requesting EML OM Notification frame 420 (in particular the same EML Mode subfield 311/312/511) and a final acknowledgment 450.

FIG. 7b illustrates a variant wherein a link bitmap is provided in the EML OM Notification frame 700′ to suggest a set of links to be used for the EML OM to activate. Any EML Control field format 300b (FIG. 3b), 300c (FIG. 5a), 300e (FIG. 5c) can be used.

Again, the EML OM Initiation Proposal from the AP MLD includes the sending, by AP MLD 402 to non-AP MLD 401, of EML OM Notification frame 700′ proposing to activate an EML OM. As being a proposal for an EML OM activation, EML OM Notification frame 700′ has its EML Mode subfield 511 or EMLSR Mode subfield 311 or EMLMR Mode subfield 312 set to 1 for activating an EML OM which is supported by the targeted non-AP MLD. In addition, EML OM Notification frame 700′ includes an EMLSR/EML Link Bitmap field 321/521, signaling a proposed set of links for activating the EML OM between the two MLDs. In this example, link bitmap “AAA” corresponding to the proposed set of links is signaled in subfield 321/521.

The sending may be responsive to a triggering event as described above.

If non-AP MLD 401 evaluates positively the opportunity to activate an EML OM as suggested by AP MLD 402, it sends, in response to the received (suggesting) frame 700′, to AP

MLD 402, a requesting EML OM Notification frame 720 requesting an activation of the EML OM, then starting any procedure processing such frame 420 (e.g. the conventional process of FIG. 4 or a process with a refusal as in FIG. 6a or 6b). The requesting EML OM Notification frame 720 also includes a link bitmap 321/521.

In some embodiments where non-AP MLD 401 follows the AP MLD's suggestion, link bitmap 321/521 of frame 720 corresponds to the same proposed set of links as frame 700′. This is the case in FIG. 7b where frame 720 also signals link bitmap “AAA”.

In some embodiments (not shown in the Figure) where non-AP MLD 401 estimates that another set of links should be used for the EML OM activation, link bitmap 321/521 of frame 720 corresponds to a set of links (e.g. “BBB”) different from the proposed set of links (“AAA”) as defined in frame 700′.

In the example of the Figure, the subsequent steps are conventional steps with an acknowledgment 430 starting the Transition Timeout timer 445 (triggering an actual activation of the requested EML OM), an EML OM Notification frame 440 identical to the requesting EML OM Notification frame 420 (in particular the same EML Mode subfield 311/312/511) and a final acknowledgment 450.

Turning now, as shown in FIG. 8, to an EML OM Termination Proposal from the AP MLD, it includes the sending, by AP MLD 402 to non-AP MLD 401, of EML OM Notification frame 800 proposing to deactivate a currently active EML OM. Any of the EML Control field formats of FIGS. 3a and 5b can be used. As being a proposal for an EML OM deactivation, EML OM Notification frame 700 has its EML Mode subfield 511 or its EMLSR Mode subfield 311 and EMLMR Mode subfield 312 set to 0 for deactivating a currently active EML OM.

The sending may be responsive to a triggering event detected locally, for example a change in network conditions that leads the AP MLD to suggest terminating the active EMLSR and/or EMLMR modes with some or all of its associated non-AP MLDs. The triggering event excludes the reception of an EML OM Notification frame requesting the same deactivation, from the non-AP MLD.

Because EML OM Notification frame 800 is received by non-AP MLD 401 without prior sending of an EML OM Notification frame, it is considered by non-AP MLD 401 as being a suggestion or proposal from AP MLD 402. Therefore, non-AP MLD 401 can evaluate the opportunity to follow the AP MLD 402′s suggestion/proposal and hence to request a deactivation of a currently active EML OM as suggested by AP MLD 402 (for example to deactivate a currently active EMLSR mode if AP MLD 402 suggests deactivating such mode).

Once non-AP MLD 401 evaluates positively the opportunity, it sends, in response to the received (suggesting) frame 800, to AP MLD 402, a requesting EML OM Notification frame 460 requesting a deactivation of the EML OM, then starting any procedure processing such frame 460 (e.g. the conventional process of FIG. 4 or a process with a refusal as in FIG. 6a or 6b). In the example of the Figure, the subsequent steps are conventional steps with an acknowledgment 470 starting the Transition Timeout timer 475 (triggering an actual deactivation of the requested EML OM), an EML OM Notification frame 480 identical to the requesting EML OM Notification frame 460 (in particular the same EML Mode subfield 311/312/511) and a final acknowledgment 490.

Turning now, as shown in FIG. 9, to an EML OM Modification Proposal from the AP MLD, it seeks to modify an EML OM currently active with a given set of links into the same EML OM (i.e. EMLSR or EMLMR) with however another set of links. The process includes the sending, by AP MLD 402 to non-AP MLD 401, of EML OM Notification frame 900 proposing to modify a currently active EML OM. Any of the EML Control field formats of FIGS. 3b, 5a and 5c can be used. Indeed, a proposed modification induces proposing a new set of links compared to those links already used by the currently active mode.

As the current signalling in the EML OM Notification frames does not directly allow signalling a modification of an EML OM, the modification process may be a two-step process with a deactivation of a currently active EML OM followed by an activation of the same EML OM with another set of links. In other words, in response to the received EML OM Notification frame 900, non-AP MLD 401 sends a first requesting EML OM Notification frame 460 requesting a deactivation of the currently active EML OM (identified in frame 900) and then sends a second requesting EML OM Notification frame 420 requesting an activation of the same EML OM with a set of links different from links of the currently active EML OM. The “same” EML OM means an EMLMR mode if the currently active EML OM that has been deactivated was EMLMR, or means an EMLSR mode if the currently active EML OM that has been deactivated was EMLSR. Preferably, to take into account the proposition of links from AP MLD 402, the different set of links in the second EML OM Notification frame 420 is the set of links proposed by AP MLD 402 in frame 900.

In the example of the Figure, AP MLD 402 suggests a set of links corresponding to link bitmap “CCC”. Hence, EML OM Notification frame 900 includes an EML Link Bitmap subfield 521 set to “CCC”.

In response to frame 900, if non-AP MLD 401 evaluates the AP MLD's suggestion as being relevant, it sends, to AP MLD 402, requesting EML OM Notification frame 460 requesting a deactivation of the currently active EML OM, then starting any procedure processing such frame 460 (e.g. the conventional process of FIG. 4). In the example of the Figure, the subsequent steps are conventional steps with an acknowledgment 470 starting the Transition Timeout timer 475 (triggering an actual deactivation of the requested EML OM), an EML OM Notification frame 480 identical to the requesting EML OM Notification frame 460 (in particular the same EML Mode subfield 311/312/511) and a final acknowledgment 490.

Next, it sends, to AP MLD 402, a requesting EML OM Notification frame 420 requesting an activation of the same EML OM with however the proposed set of claims, then starting any procedure processing such frame 420 (e.g. the conventional process of FIG. 4 or a process with a refusal as in FIG. 6a or 6b). The requesting EML OM Notification frame 420 includes a link bitmap 321/521 set to the proposed bitmap “CCC”.

In the example of the Figure, the subsequent steps are conventional steps with an acknowledgment 430 starting the Transition Timeout timer 445 (triggering an actual activation of the requested EML OM), an EML OM Notification frame 440 identical to the requesting EML OM Notification frame 420 (in particular the same EML Mode subfield 311/312/511 and same link bitmap) and a final acknowledgment 450.

In a variant not shows, non-AP MLD 401 may send, in response to frame 900, an EML OM Notification frame 900′ that includes a “modification” signaling (e.g. a particular flag), with the proposed set of links “CCC”. This is to avoid the two steps of the above two-step approach.

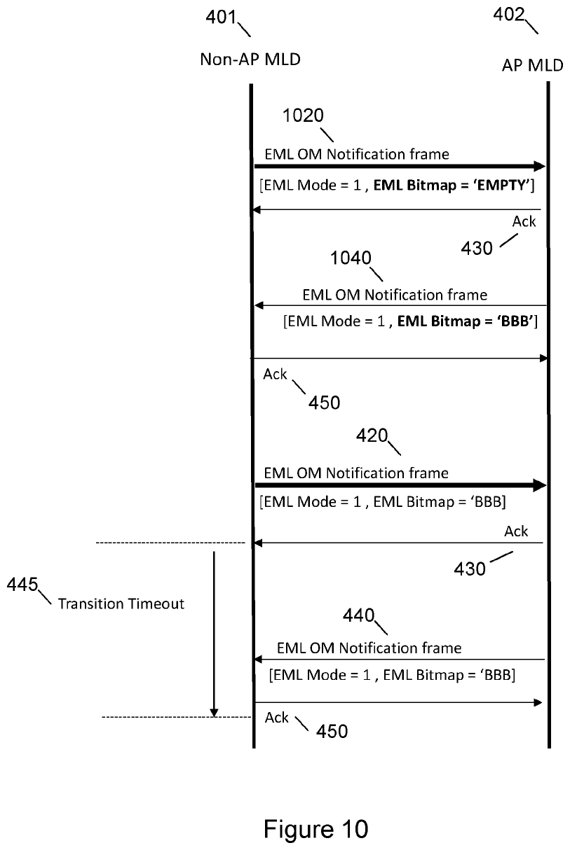

Another way for the AP MLD to provide suggestions or proposals to the non-AP MLD is now described with reference to FIG. 10. In the scenario, non-AP MLD still initiates the activation of an EML OM but either asks the AP MLD for a set of links to be used or provides a set of links that does not satisfy the AP MLD.

In this scenario, the AP MLD thus reacts to a requesting frame from the non-AP MLD: responsive to receiving, from the non-AP MLD, a first requesting EML OM Notification frame requesting an activation of an EML OM, the AP MLD sends, to the non-AP MLD, a responding EML OM Notification frame signaling a proposed set of links for activating the EML OM.

As shown in the Figure, non-AP MLD 401 sends, to AP MLD 401, a first requesting EML OM Notification frame 1000 requesting an activation of an EML OM. Any of the EML Control field formats of FIGS. 3b, 5a and 5c can be used, i.e. frame 1020 includes an EML Link Bitmap subfield 521.

In some embodiments (as the one shown in the Figure), the EML Link Bitmap subfield 521 of frame 1020 is empty or has a predefined bit pattern (all bits to 0, or bit corresponding to a not-existing enabled link set to 1). This is an invitation for AP MLD 402 to indicate (in response) which links to be used for the requested EML OM.

In other embodiments (not shown), the EML Link Bitmap subfield 521 of frame 1000 may be set to a given set of links (i.e. some enabled links are signaled).

A conventional acknowledgment 430 is sent by AP MLD 402. To avoid activating the EML OM with an empty set of links, the MLDs do not start their local Transition Timeout timer 445 based on acknowledgment 430, as an exception to the conventional approach. This mechanism may be based on the link bitmap in frame 1020: the MLD does not start its local Transition Timeout timer upon sending/receiving an acknowledgment to a requesting EML OM Notification frame 1020 when the latter includes an EML Link Bitmap field 521 to signal links that is empty.

Next, AP MLD 402 sends, to non-AP MLD 401, responding EML OM Notification frame 1040 which sets its EML Mode subfield 311/312/511 to the same activation value (here 1) as requesting frame 1020 and signals a set of links AP MLD 402 proposes for activating the requested EML OM. In the example, the set of links corresponding to link bitmap “BBB” is proposed. A conventional acknowledgment 450 is sent by non-AP 402. The proposed set of links is different from the set of links optionally specified in frame 1020.

Non-AP MLD 401 may next evaluate the opportunity to activate an EML OM using the set of links as suggested by AP MLD 402. In the negative, nothing more happens. In the affirmative, it sends, in response to receiving the responding EML OM Notification frame 1040, a second requesting EML OM Notification frame 420 requesting the activation of the EML OM using the proposed set of links “BBB”. The procedure that follows to process such frame 420 may be the conventional process of FIG. 4 (or alternatively a process with a refusal as in FIG. 6a or 6b): an acknowledgment 430 starting the Transition Timeout timer 445 (triggering an actual activation of the requested EML OM) is followed by an EML OM Notification frame 440 identical to the requesting EML OM Notification frame 420 (in particular the same EML Mode subfield 311/312/511) and a final acknowledgment 450.

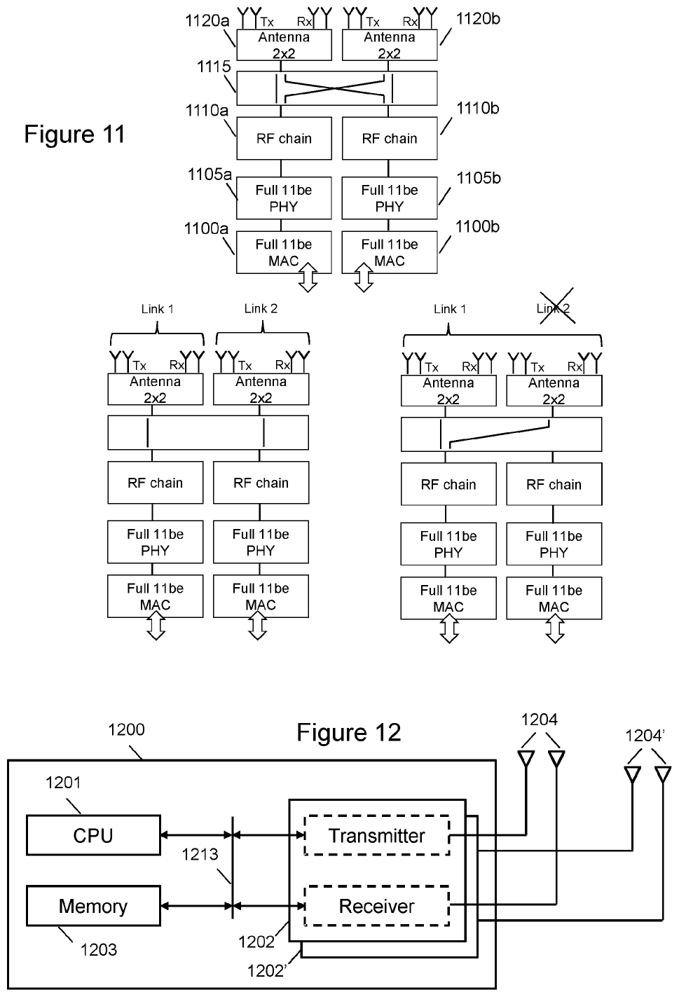

FIG. 11 schematically illustrates an EMLMR capable architecture for an MLD. This Figure takes the example of two affiliated non-AP STAs sharing their antenna resources when the EMLMR mode is activated.

The architecture comprises two radio stacks, one for each non-AP STA.

A radio stack comprises a full 802.11be MAC module 1100a or 1100b (exchanging data with higher layers), a full 802.11be PHY module 1105a or 1105b connected with the MAC module, a radio-frequency chain 1110a or 1110b connected with the PHY module, an EMLMR switch 1115 shared by the two radio stacks and configured to perform the aggregation of the antenna resources when the EMLMR mode is activated, and an antenna array 1120a or 1120b.

The diagram on the bottom left illustrates the functioning when the EMLMR mode is disabled: the common EMLMR switch 1115 connects each antenna array to its RF chain. Hence, each radio stack is complete and can serve a respective link using for example a 2×2 MIMO antenna configuration. As shown in the Figure, two links are available.

The diagram on the bottom right illustrates the functioning when the EMLMR mode is activated: the common EMLMR switch 1115 aggregates the antenna resource to the first link. To do so, it connects the antenna array 1120b of the second radio stack to the RF chain 1110a of the first radio stack. Hence, the first radio stack can operate in a 4×4 MIMO antenna configuration to improve the throughput of link 1. On the other hand, link 2 can no longer be used as its antenna array 1120b is no longer available for the second radio stack.

Although the illustrative aggregation of the antenna resources deprives the second radio stack of all its antenna resources in the EMLMR mode, it may be contemplated that the EMLMR mode only aggregate a part of these antenna resources to the first radio stack.

FIG. 12 schematically illustrates a communication device 1200, typically any of the MLDs discussed above, of a wireless network, configured to implement at least one embodiment of the present invention. The communication device 1200 may preferably be a device such as a micro-computer, a workstation or a light portable device. The communication device 1200 comprises a communication bus 1213 to which there are preferably connected:
a central processing unit 1201, such as a processor, denoted CPU;
a memory 1203 for storing an executable code of methods or steps of the methods according to embodiments of the invention as well as the registers adapted to record variables and parameters necessary for implementing the methods; and
at least two communication interfaces 1202 and 1202′ connected to the wireless communication network, for example a communication network according to one of the IEEE 802.11 family of standards, via transmitting and receiving antennas 1204 and 1204′, respectively.

Preferably the communication bus 1213 provides communication and interoperability between the various elements included in the communication device 1200 or connected to it. The representation of the bus is not limiting and in particular the central processing unit is operable to communicate instructions to any element of the communication device 1200 directly or by means of another element of the communication device 1200.

The executable code may be stored in a memory that may either be read only, a hard disk or on a removable digital medium such as for example a disk. According to an optional variant, the executable code of the programs can be received by means of the communication network, via the interface 1202 or 1202′, in order to be stored in the memory of the communication device 1200 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1-22. (canceled)

23. A communication method in a wireless network, comprising at a requested multi-link device, MLD:
receiving, from a requesting MLD, a requesting Enhanced Multi-Link, EML, Operating Mode, OM, Notification frame requesting an activation or deactivation of an EML Single-Radio, EMLSR, OM or of an EML Multi-Radio, EMLMR, OM,
wherein the requesting EML OM Notification frame includes a single bitmap subfield that indicates either a set of links to be used in the EMLSR OM if the requesting EML OM Notification frame requests an activation of the EMLSR OM or a set of links to be used in the EMLMR OM if the requesting EML OM Notification frame requests an activation of the EMLMR OM.

24. A communication method in a wireless network, comprising at a requesting multi-link device, MLD:
sending, to a requested MLD, a requesting Enhanced Multi-Link, EML, Operating Mode, OM, Notification frame requesting an activation or deactivation of an EML Single-Radio, EMLSR, OM or of an EML Multi-Radio, EMLMR, OM,
wherein the requesting EML OM Notification frame includes a single bitmap subfield that indicates either a set of links to be used in the EMLSR OM if the requesting EML OM Notification frame requests an activation of the EMLSR OM or a set of links to be used in the EMLMR OM if the requesting EML OM Notification frame requests an activation of the EMLMR OM.

25. The method of claim 23, wherein the requesting EML OM Notification frame is deprived of bitmap subfields indicating a set of links for an EML OM, if the requesting EML OM Notification frame requests a deactivation of both EMLSR OM and EMLMR OM.

26. The method of claim 23, wherein the requesting EML OM Notification frame includes an EMLSR Mode subfield to be set to 1 or 0 to respectively request an activation or deactivation of the EMLSR mode and an EMLMR Mode subfield to be set to 1 or 0 to respectively request an activation or deactivation of the EMLMR mode.

27. The method of claim 26, wherein when the EMLSR Mode subfield is set to 1, the single bitmap subfield indicates a set of links to be used in the EMLSR OM, when the EMLMR Mode subfield is set to 1, the single bitmap subfield indicates a set of links to be used in the EMLMR OM, and when the EMLSR Mode subfield is set to 0 and the EMLMR Mode subfield is set to 0, the requesting EML OM Notification frame is deprived of bitmap subfields indicating a set of links for an EML OM.

28. A communication method in a wireless network, comprising at a requested multi-link device, MLD:
receiving, from a requesting MLD, a first requesting Enhanced Multi-Link Operating Mode, EML OM, Notification frame requesting an activation of an EML OM, the first requesting EML OM Notification frame including a field signaling a set of links to be used in the EML OM,
exchanging data with the requesting MLD using the activated EML OM, and
receiving, from the requesting MLD, a second requesting EML OM Notification frame requesting a deactivation of the activated EML OM, the second requesting EML OM Notification frame being deprived of a field signaling a set of links.

29. A communication method in a wireless network, comprising at a requesting multi-link device, MLD:
sending, to a requested MLD, a first requesting Enhanced Multi-Link Operating Mode, EML OM, Notification frame requesting an activation of an EML OM, the first requesting EML OM Notification frame including a field signaling a set of links to be used in the EML OM,
exchanging data with the requested MLD using the activated EML OM, and
sending, to the requested MLD, a second requesting EML OM Notification frame requesting a deactivation of the activated EML OM, the second requesting EML OM Notification frame being deprived of a field signaling a set of links.

30-38. (canceled)

39. A wireless communication device comprising at least one microprocessor configured for carrying out the steps of any of the communication method of claim 23.

40. A non-transitory computer-readable medium storing a program which, when executed by a microprocessor or computer system in a wireless device, causes the wireless device to perform the communication method of claim 23.

24. The method of claim 24, wherein the requesting EML OM Notification frame is deprived of bitmap subfields indicating a set of links for an EML OM, if the requesting EML OM Notification frame requests a deactivation of both EMLSR OM and EMLMR OM.

24. The method of claim 24, wherein the requesting EML OM Notification frame includes an EMLSR Mode subfield to be set to 1 or 0 to respectively request an activation or deactivation of the EMLSR mode and an EMLMR Mode subfield to be set to 1 or 0 to respectively request an activation or deactivation of the EMLMR mode.

43. A wireless communication device comprising at least one microprocessor configured for carrying out the steps of any of the communication method of claim 24.

44. A wireless communication device comprising at least one microprocessor configured for carrying out the steps of any of the communication method of claim 29.

45. A non-transitory computer-readable medium storing a program which, when executed by a microprocessor or computer system in a wireless device, causes the wireless device to perform the communication method of claim 24.

46. A non-transitory computer-readable medium storing a program which, when executed by a microprocessor or computer system in a wireless device, causes the wireless device to perform the communication method of claim 28.

47. A non-transitory computer-readable medium storing a program which, when executed by a microprocessor or computer system in a wireless device, causes the wireless device to perform the communication method of claim 29.
